(19) United States
(12) Patent Application Publication
(10) Pub. No.: US 2026/0158592 A1
(43) Pub. Date: Jun. 11, 2026

(54) WATER-JET GUIDED LASER MACHINING DEVICE AND METHOD UNDER MULTIPLE COMBINATIONS OF WATER AND AIR

(71) Applicant: HARBIN WELDING INSTITUTE LIMITED COMPANY, Harbin, Heilongjiang (CN)

(72) Inventors: Ruisheng HUANG, Harbin, Heilongjiang (CN); Qian SUN, Harbin, Heilongjiang (CN); Yandong ZHANG, Harbin, Heilongjiang (CN); Rong LI, Harbin, Heilongjiang (CN); Xin NIE, Harbin, Heilongjiang (CN); Xiaoyu CHEN, Harbin, Heilongjiang (CN); Bao JIANG, Harbin, Heilongjiang (CN)

(73) Assignee: HARBIN WELDING INSTITUTE LIMITED COMPANY, Harbin, Heilongjiang (CN)

(21) Appl. No.: 18/293,653

(22) PCT Filed: Nov. 13, 2023
(86) PCT No.: PCT/CN2023/131245

§ 371 Date: Jan. 30, 2024

(30) Foreign Application Priority Data
Aug. 28, 2023 (CN) 202311087504.7

(51) Int. Cl. B23K 26/146; B23K 26/14; B23K 26/38

(52) U.S. Cl. CPC B23K 26/146; B23K 26/1462; B23K 26/38

(57) ABSTRACT

A water-jet guided laser machining device and method under multiple combinations of water and air is provided. An auxiliary atmosphere input line is arranged between a laser-water coupling device and an annular water-jet device. An auxiliary atmosphere input through the auxiliary atmosphere input line is sprayed from an annular gas nozzle to form an auxiliary airflow layer. A nozzle is arranged at a lower end of the laser-water coupling device. An annular liquid nozzle is arranged at a bottom of the annular water-jet device. The laser-water coupling device is configured for coupling a laser beam with an internal liquid to spray a single water jet from the nozzle. The annular water-jet device is configured for spraying the internal liquid from the annular liquid nozzle to form an annular water curtain around a laser guiding water jet. The auxiliary airflow layer is enclosed in the annular water curtain.

### CROSS-REFERENCE TO RELATED APPLICATION

This application is a national stage application of International Patent Application No. PCT/CN2023/131245, filed Nov. 13, 2023, which claims priority of the Chinese Patent Application No. 202311087504.7, filed on Aug. 28, 2023, both of which are incorporated by references in their entities.

### TECHNICAL FIELD

The present disclosure belongs to the technical field of laser machining, and specifically relates to a water-jet guided laser machining device and method under multiple combinations of water and air.

### BACKGROUND

In high-end manufacturing enterprises for aerospace equipment, medical equipment and semiconductor micromachining, the technical requirements for machining precision, efficiency, thermal damage, and fracture quality are extremely high in the manufacturing of many key precision components, and it is difficult for conventional machining methods to effectively meet the above requirements. Water-jet guided laser technology is a green, efficient, and precision machining technology. The principle of the technology is as follows: coupling a high-energy laser beam into a fine water jet, and guiding the laser to a surface of a workpiece by the water jet to perform precision hot working such as cutting, punching and grooving on the workpiece, while excess heat and residue are taken away by the water jet. Therefore, water-jet guided laser technology can achieve precise control of high-density energy in a “cold and heat source” mode, and ultra-precise, efficient, and high-quality notches are obtained. Water-jet guided laser technology is very suitable for fine machining of high-temperature alloy, wafers, carbon fibers, and other materials, as well as machining of components for biomedical instruments. However, the precision machining capability of water-jet guided laser is determined by two key factors, namely the diameter of the water jet and the stable length of the water jet. Because the diameter of the water jet in water-jet guided laser has a great influence on machining accuracy, the smaller the diameter of a nozzle, the smaller the diameter of the water jet sprayed, and the higher the machining accuracy. In addition, the machining depth and machining distance of the water-jet guided laser depend on the length of the stable laser guiding water jet, that is, the length of the jet segment with the best laser guiding effect in the laser guiding water jet. The jet segment has the characteristics of a bright, clean and smooth surface, and a liquid flow in a compact cylindrical shape. Therefore, the two technical indicators are extremely concerned in the industry. However, it is difficult to achieve simultaneous enhancement of the two indicators. The high-pressure water jet is subjected to intense friction with the surrounding air after being ejected from the nozzle, resulting in a gradual disturbance of the internal stable laminar flow state. Therefore, the water jet becomes unstable after being ejected for a certain distance, breaks into water droplets, and the channel for coupling laser with water is destroyed. Research has shown that the smaller the diameter of the water jet, the greater the influence, and the shorter the length of the stable water jet. Even if some researchers have applied an auxiliary atmosphere at the nozzle of the water jet to isolate air and increase the length of stable liquid flow to some extent, the auxiliary atmosphere is also subjected to intense friction with the surrounding air after being ejected, so that the distance for the auxiliary atmosphere to maintain a compact state is extremely limited, and the protection is ineffective when the auxiliary atmosphere spreads for a certain distance. Therefore, the current water-jet guided laser technology is still conflicted in terms of machining accuracy and machining thickness, and it is difficult to guarantee both the machining accuracy and the machining thickness at the same time.

During the process of water-jet guided laser machining, the fine laser guiding water jet is easily subjected to intense friction with the surrounding air when sprayed, gradually becomes unstable, and the channel for stably guiding laser is destroyed. Therefore, how to effectively increase the length of the stable water jet is a key problem.

### SUMMARY

The purpose of the present disclosure is to provide a water-jet guided laser machining device and method under multiple combinations of water and air, so that the length of the stable water jet is effectively increased and the machining stability is enhanced, while a diameter of the water jet is kept constant.

The above purpose is achieved through the following technical solution.

In the present disclosure, a water-jet guided laser machining device under multiple combinations of water and air is proposed, the water-jet guided laser machining device includes a laser-water coupling device 2, an annular water-jet device 3, a nozzle 4, an annular liquid nozzle 5, and an auxiliary atmosphere input line 9.

The auxiliary atmosphere input line 9 is arranged between the laser-water coupling device 2 and the annular water-jet device 3. An auxiliary atmosphere input through the auxiliary atmosphere input line 9 is sprayed from an annular gas nozzle 6 to form an auxiliary airflow layer 8. The nozzle 4 is arranged at a lower end of the laser-water coupling device 2. The annular liquid nozzle 5 is arranged at a bottom of the annular water-jet device 3. The laser-water coupling device 2 is configured for coupling a laser beam 1 with an internal liquid to spray a single water jet 10 from the nozzle 4. The annular water-jet device 3 is configured for spraying the internal liquid from the annular liquid nozzle 5 to form an annular water curtain 7 around the laser guiding water jet 10. The auxiliary airflow layer 8 is enclosed in the annular water curtain 7.

Further, the single water jet 10, the auxiliary airflow layer 8, and the annular water curtain 7 form a coaxially combined structure from inside to outside, that is, a coaxially combined structure under multiple combinations of water and air from inside to outside.

Further, the annular water-jet device 3 is connected to the lower end of the laser-water coupling device 2.

Further, a laser emitting device configured for emitting the laser beam 1 into the laser-water coupling device 2 is arranged above the laser-water coupling device 2.

Further, the laser beam 1 includes a single energy beam or a combination energy beam.

Further, high-pressure water inlets are formed in both the laser-water coupling device 2 and the annular water-jet device 3.

In the present disclosure, a water-jet guided laser machining method under multiple combinations of water and air is proposed, the water-jet guided laser machining method includes the following steps:
step 1, spraying water from the water-jet guided laser machining device at a high speed under a pressure to form a single water jet;
step 2, coaxially combining an auxiliary atmosphere to enclose the single water jet formed in step 1, and coaxially combining another annular water curtain outside the auxiliary atmosphere to form a coaxially combined structure under multiple combinations of water and air from inside to outside; and
step 3, coupling a high-energy laser beam into the single water jet formed in step 1 to form a laser guiding water jet, and spraying the laser guiding water jet together with the auxiliary atmosphere and the annular water curtain onto a surface of a workpiece to be machined.

Further, a diameter of the single water jet in step 1 is in a range of 10-600 μm, and a pressure of water is in a range of 0-100 MPa.

Further, a pressure of gas in the auxiliary atmosphere in step 2 is in a range of 0.1-10 MPa.

Further, water in the laser-water coupling device and the annular water-jet device includes purified water, distilled water, or other liquids meeting the requirements for guiding laser.

The present disclosure has the following beneficial effects.

In the present disclosure, the length of the stable water jet can be effectively increased and the machining stability can be enhanced while keeping the diameter of the water jet constant.

In the present disclosure, during the process of water-jet guided laser cutting, punching, grooving and the like, the length of the stable jet is increased, the machining stability and the anti-interference ability are improved.

The effect of increasing the length of the stable water jet in the present disclosure is much better than that in the conventional auxiliary atmosphere protection method. In the conventional auxiliary atmosphere protection method, a coaxial auxiliary atmosphere is applied outside the laser guiding water jet. Although the effects of isolating the air and increasing the length of the stable laser guiding water jet can be achieved to some extent, the auxiliary atmosphere is also subjected to intense friction caused by environmental resistance when making direct contact with the air. Therefore, the distance for the auxiliary atmosphere to maintain a compact state is extremely limited. After spraying for a certain distance, the airflow will deviate from the axis direction and spread outward, and the density and uniformity of the airflow will also be decreased. Meanwhile, external gas can enter the airflow in the form of turbulent flow, so that the laser guiding water jet is disturbed, and the protection by the auxiliary atmosphere is also ineffective. According to the multiple water-air combination design of the present disclosure, an annular water curtain is further added outside the original auxiliary atmosphere. The purpose of the present disclosure is that because the density of water is much higher than that of gas, the impulse of the annular water curtain sprayed is larger than that of the auxiliary atmosphere, the annular water curtain is less likely to be affected by the surrounding atmosphere, resulting in the destruction of the spraying form. Therefore, the annular water curtain is higher in stability and compactness, longer in distance of stable spraying and better in isolation effect on external gas than those of the auxiliary atmosphere sprayed alone. Furthermore, since the annular water curtain is not involved in the hot working process, the width of liquid flow will not affect the machining accuracy. Therefore, the protection distance for effectively isolating air can be greatly increased by appropriately increasing the width of the annular liquid flow.

In the present disclosure, the design of the annular water curtain can prevent the internal auxiliary atmosphere from spreading outward, and enable the internal auxiliary atmosphere move in the same direction as the auxiliary atmosphere, so that the stable flow state of the auxiliary atmosphere can be effectively restricted and maintained, the distance for the auxiliary atmosphere to maintain in a compact state can be increased, and the length of the stable laser guiding water jet in the auxiliary atmosphere can also be increased.

Through the water-jet guided laser machining method under multiple combinations of water and air in the present disclosure, with the combination of the annular water curtain, excess machining heat and cutting residue can be effectively taken away. Therefore, the heat affected zone of the obtained notches is smaller and the quality of the notches is better.

The water-jet guided laser machining device under multiple combinations of water and air in the present disclosure is simple in structure and easy to implement, and has more combined beneficial effects, obvious effects and high practicability.

### BRIEF DESCRIPTION OF THE DRAWINGS

FIG. 1 is a schematic diagram of a structure of the water-jet guided laser machining device under multiple combinations of water and air according to an embodiment of the present disclosure.

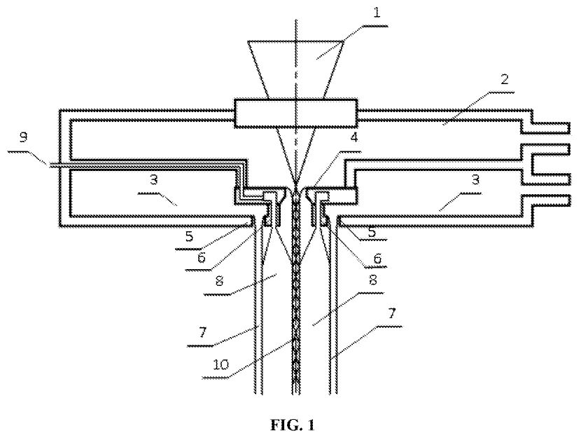

FIG. 2 is a flow chart of the water-jet guided laser machining method under multiple combinations of water and air according to an embodiment of the present disclosure.

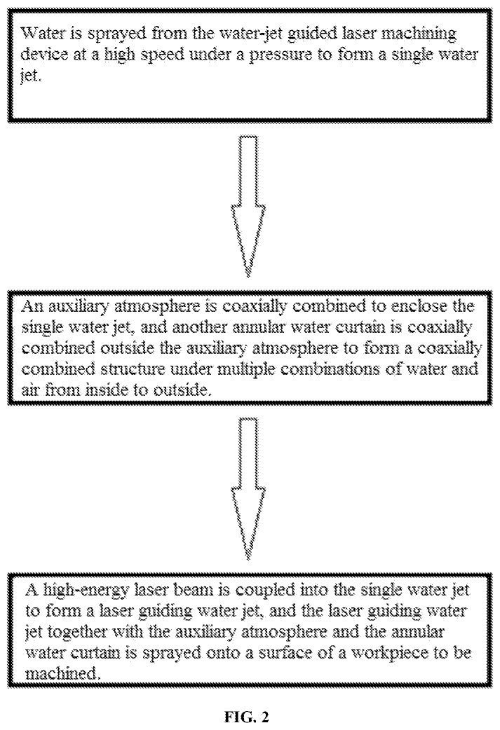

### DETAILED DESCRIPTION OF THE EMBODIMENTS

In the following description, for the purpose of illustration rather than limitation, specific details such as specific system structures and technologies are mentioned for thorough understanding the embodiments of the present disclosure. However, those skilled in the art should understand that, the present disclosure may also be implemented in other embodiments without these specific details. In other cases, detailed illustration of well-known systems, devices, circuits, and methods are omitted to prevent unnecessary details from affecting description of the present disclosure.

It should be understood that the term “including”, when used in present specification and the appended claims, indicates the presence of the described features, integers, steps, operations, elements and/or components, but does not exclude the presence or addition of one or more other features, integers, steps, operations, elements, components and/or groups thereof.

It also should be understood that the terms used in the specification of the present disclosure are merely intended to describe specific embodiments and not intended to limit the present disclosure. As used in the specification of the present disclosure and the appended claims, singular forms of “a”, “an” and “the” are intended to include plural forms unless the context clearly indicates other situations.

The technical solutions in the embodiments of the present disclosure are clearly and completely described in following with reference to the drawings in the embodiments of the present disclosure. Apparently, the described embodiments are only a part rather than all of the embodiments of the present disclosure. All other embodiments obtained by those skilled in the art based on the embodiments of the present disclosure without creative efforts shall fall within the protection scope of the present disclosure.

Numerous specific details are set forth in the following description to provide a thorough understanding of the present disclosure, but the present disclosure may be implemented in other ways different from those described herein. Those skilled in the art can make similar promotion without departing from the concept of the present disclosure. Therefore, the scope of the present disclosure is not limited by the specific embodiments disclosed below.

The present disclosure provides a combined water-jet guided laser machining method, wherein an auxiliary atmosphere and an annular water curtain are coaxially combined outside a laser guiding water jet in sequence to form a three-layer structure from inside to outside, with the laser guiding water jet as a center, the auxiliary atmosphere as an inner layer, and the annular water curtain as an outer layer.

In the present disclosure, a water-jet guided laser machining device under multiple combinations of water and air is proposed. The water-jet guided laser machining device includes a laser-water coupling device 2, an annular water-jet device 3, a nozzle 4, an annular liquid nozzle 5, and an auxiliary atmosphere input line 9.

The auxiliary atmosphere input line 9 is arranged between the laser-water coupling device 2 and the annular water-jet device 3. An auxiliary atmosphere input through the auxiliary atmosphere input line 9 is sprayed from an annular gas nozzle 6 to form an auxiliary airflow layer 8. The nozzle 4 is arranged at a lower end of the laser-water coupling device 2. The annular liquid nozzle 5 is arranged at a bottom of the annular water-jet device 3. The laser-water coupling device 2 is configured for coupling a laser beam 1 with an internal liquid to spray a single water jet 10 from the nozzle 4. The annular water-jet device 3 is configured for spraying the internal liquid from the annular liquid nozzle 5 to form an annular water curtain 7 around the laser guiding water jet 10. The auxiliary airflow layer 8 is enclosed in the annular water curtain 7.

Further, the single water jet 10, the auxiliary airflow layer 8 and the annular water curtain 7 form a coaxially combined structure from inside to outside, that is, a coaxially combined structure under multiple combinations of water and air from inside to outside.

When the laser beam 1 is incident into the laser-water coupling device 2, the laser beam is converged at an inlet of the nozzle 4 and coupled into the single water jet 10 to form the laser guiding water jet. The laser guiding water jet together with the auxiliary atmosphere 8 and the annular water curtain 7 are sprayed onto a surface of a workpiece to be machined.

Further, the annular water-jet device 3 is connected to the lower end of the laser-water coupling device 2. By integrating the annular water-jet device 3 with the laser-water coupling device 2, space can be reduced, and it is more conducive to arrange the nozzle 4 and the annular liquid nozzle 5 in a coaxial form. A flange is arranged at a lower end of the nozzle 4, and a stable annular water curtain 7 can be formed by combining the flange with the annular liquid nozzle 5.

Further, a laser emitting device configured for emitting the laser beam 1 into the laser-water coupling device 2 is arranged above the laser-water coupling device 2.

Further, the laser beam 1 includes a single energy beam or a combination energy beam. The device can adapt to different types of laser beams, and is high in universality. The device can be realized by installing different types of laser emitters.

Further, high-pressure water inlets are formed in both the laser-water coupling device 2 and the annular water-jet device 3. In this arrangement, hydraulic pressure in the laser-water coupling device 2 and the annular water-jet device 3 can be controlled separately, and thus the independent regulation of the laser guiding water jet and the annular water curtain jet can be realized. The high-pressure water inlets of the laser-water coupling device 2 and the annular water-jet device 3 can be arranged on the same side to facilitate installation, and the arrangement of high-pressure water pipelines is also more reasonable.

In the present disclosure, a water-jet guided laser machining method under multiple combinations of water and air is proposed. The water-jet guided laser machining method includes the following steps:
Step 1, water is sprayed from the water-jet guided laser machining device at a high speed under a pressure to form a single water jet.
Step 2, an auxiliary atmosphere is coaxially combined to enclose the single water jet formed in step 1, and another annular water curtain is coaxially combined outside the auxiliary atmosphere to form a coaxially combined structure under multiple combinations of water and air.

The auxiliary atmosphere and the single water jet inside the auxiliary atmosphere are coaxially sprayed out in the same direction, so that the laminar flow characteristics of the single water jet is maintained, the length of the stable jet is increased, and the single water jet is prevent from contacting with the annular water curtain, maintaining a complete liquid-air interface film for the single water jet, and thus maintaining a total reflection propagation of the laser beam in the single water jet.

Step 3, a high-energy laser beam is coupled into the single water jet formed in step 1 to form a laser guiding water jet, and the laser-guide water jet together with the auxiliary atmosphere and the annular water curtain is sprayed onto a surface of a workpiece to be machined.

The auxiliary atmosphere is enclosed in the annular water curtain. The annular water curtain is not involved in the hot working process, and is mainly used for isolating an external gas flow field from the auxiliary atmosphere, so that the internal auxiliary atmosphere is prevented from spreading outward, and enabling the internal auxiliary atmosphere to move in the same direction as the auxiliary atmosphere, so that the environmental friction resistance applied on the auxiliary atmosphere during spraying is reduced. Therefore, a stable flow state of the auxiliary atmosphere can be effectively restricted and maintained, the protection effect of the auxiliary atmosphere on the single water jet can be enhanced, and the purpose of further increasing the length of the stable jet can be achieved.

Further, a diameter of the single water jet in step 1 is in a range of 10-600 μm, and a pressure of water is in a range of 0-100 MPa.

Further, a pressure of gas in the auxiliary atmosphere in step 2 is in a range of 0.1-10 MPa.

In this arrangement, the single water jet 10 is enclosed in the auxiliary atmosphere, and a good and normal cutting effect can still be ensured in case that the annular water curtain 7 is slightly offset towards the single water jet 10.

Further, water in the laser-water coupling device and the annular water-jet device includes purified water, distilled water, or other liquids meeting the requirements for guiding laser.

1. A water-jet guided laser machining device under multiple combinations of water and air, wherein the water-jet guided laser machining device comprises a laser-water coupling device, an annular water-jet device, a nozzle, an annular liquid nozzle, and an auxiliary atmosphere input line,
the auxiliary atmosphere input line is arranged between the laser-water coupling device and the annular water-jet device, an auxiliary atmosphere input through the auxiliary atmosphere input line 9 is sprayed from an annular gas nozzle to form an auxiliary airflow layer, the nozzle is arranged at a lower end of the laser-water coupling device, the annular liquid nozzle is arranged at a bottom of the annular water-jet device, the laser-water coupling device is configured for coupling a laser beam with an internal liquid to spray a single water jet from the nozzle, the annular water-jet device is configured for spraying the internal liquid from the annular liquid nozzle to form an annular water curtain around a laser guiding water jet, and the auxiliary airflow layer is enclosed in the annular water curtain.

2. The water-jet guided laser machining device according to claim 1, wherein the single water jet, the auxiliary airflow layer, and the annular water curtain form a coaxially combined structure from inside to outside, that is, an coaxially combined structure under multiple combinations of water and air from inside to outside.

3. The water-jet guided laser machining device according to claim 1, wherein the annular water-jet device is connected to the lower end of the laser-water coupling device.

4. The water-jet guided laser machining device under multiple combinations of water and air according to claim 1, wherein a laser emitting device configured for emitting the laser beam into the laser-water coupling device is arranged above the laser-water coupling device.

5. The water-jet guided laser machining device according to claim 1, wherein the laser beam includes a single energy beam or a combination energy beam.

6. The water-jet guided laser machining device according to claim 1, wherein high-pressure water inlets are formed in both the laser-water coupling device and the annular water-jet device.

7. A water-jet guided laser machining method under multiple combinations of water and air, wherein the water-jet guided laser machining method comprises the following steps:
step 1, spraying water from the water-jet guided laser machining device according to claim 1 at a high speed under a pressure to form a single water jet;
step 2, coaxially combining an auxiliary atmosphere to enclose the single water jet formed in step 1, and coaxially combining another annular water curtain outside the auxiliary atmosphere to form a coaxially combined structure under multiple combinations of water and air; and
step 3, coupling a high-energy laser beam into the single water jet formed in step 1 to form a laser guiding water jet, and spraying the laser guiding water jet together with the auxiliary atmosphere and the annular water curtain onto a surface of a workpiece to be machined.

8. The water-jet guided laser machining method according to claim 7, wherein a diameter of the single water jet in step 1 is in a range of 10-600 μm, and a pressure of water is in a range of 0-100 MPa.

9. The water-jet guided laser machining method according to claim 7, wherein a pressure of gas in the auxiliary atmosphere in step 2 is in a range of 0.1-10 MPa.

10. The water-jet guided laser machining method according to claim 7, wherein water in the laser-water coupling device and the annular water-jet device includes purified water, distilled water, or other liquids meeting requirements for guiding laser.
